(19) United States
(12) Patent Application Publication
(10) Pub. No.: US 2005/0043937 A1
(43) Pub. Date: Feb. 24, 2005

(54) Syntax pieces to master colloquial American English

(76) Inventor: Saul Munoz, El Paso, TX (US)

Correspondence Address: SAUL MUNOZ, 3230 ISLA MORADA Dr., EL PASO, TX, 79925, US

(21) Appl. No.: 10/897,193

(22) Filed: Jul. 22, 2004

Related U.S. Application Data
(60) Provisional application No. 60/490,053, filed on Jul. 25, 2003.

(51) Int. Cl. G06F 17/28

(52) U.S. Cl. 704/5

(57) ABSTRACT

A portion of syntax rules of the American English Language transformed into eleven (FIGS. 1a-11) different color and shape manipulative pieces of cardboard; eight pieces (FIGS. 4-11) represent twenty four auxiliary verbs, and seven interrogative particles, plus the word “not”; the other three items (FIGS. 1a-2a-3a) represent the subject-verb-object sentence, and each one of these three items, has an affixed stripe of paper of the specific color required. Horizontally aligned from left to right, these three items form two slots before 1a, and four spaces after the same 1a; the six empty positions receive none or up to six pieces of said manipulative items that contain the matching auxiliaries to construct a predetermined simple sentence sketch, this sentence structure is the pattern code to design a chart with five horizontal lanes to accommodate sketches for the declarative, interrogative, interrogative-negative, affirmative, and the negative kind of sentences; each chart features through said sketches, voice, tense, mood, and aspect. Having the senences Patterns charts on sight, facilitates your working with two or three dimension pieces, as well as with a computer program. These pattern charts rule the drilling activity with the pieces of syntax, drilling that you have to do until without referring to the charts, you make it possible to obtain syntactic correct sentences.

### CROSS-REFERENCE TO RELATED APPLICATIONS

This application is entitled to the benefit of provisional patent application Ser. No. 60/490,053 filed 2003 Jul. 25.

### BACKGROUND

1. Field of Invention

This invention facilitates the learning of American English as a Second Language, by simplifying the mastering of grammar rules through syntactically designed items.

2. Description of Prior-Art

The acquisition of American English as a Second Language is being made by subconscious or conscious memorization of its basic aspects, Semantics, Phonology, Syntax, and Morphology, under different intensive-extensive application phases; the very young learners, as well as the older ones who experience total immersion techniques, are using the subconscious procedure, the rest of the learners work through formal academic courses to achieve the same goals; among the mentioned aspects, Syntax appears with a higher degree of difficulty due to its rules and exceptions, and still, the syntactic approaches followed by English as a Second Language methods, instructors, and students are at both exremes, from totally ignoring these mentioned grammar rules, to overdoing them in exhaustive courses.

### SUMMARY

This is a method of approaching the rules of Syntax of the American English Language, using objects, colors, positions and their relationship, comprising manipulative pieces not bigger than 10 cm. by 5. cm., that contain and represent syntax rules for sentences and for speech

### OBJECTS AND ADVANTAGES

Besides the mastery of Syntax, and helping the learner in the whole process of acquiring proficiency in the American English Language, other derived advantages are:
A) to provide a model on how to convert an abstract idea, in this case grammar rules, into objects, and how to manipulate such objects in a synergetic way, to obtain and use sophisticated concepts.
B) to provide the learner, when it comes to pattern drills, with a tool that allows working at the same time, with both, syntax rules, and specific vocabulary
C) to provide both subconscious and conscious learners with an optional tool to work under precise instructions, so as to attain predictable goals in their syntax challenges.
D) to provide a methodology on how to organize sentence patterns with lexicon of any specific discipline.
E) to save time and effort when trying to master grammar rules of the American English Language.

### DRAWING FIGURES

In the drawings, three closely related figures have sequenced numbers, and sequenced alphabetic suffixes, as they represent the only three pieces on this invention, that keep a fixed structured relationship.

FIGS. 1a, 2a, and 3a, as presented together in a row, show the arrangement of the elements of a simple sentence of the form subject, verb, object: “s-v-o”,

FIG. 1a shows a rectangular piece representing a subject, and a stripe that shows a piece of paper that may contain any of the eight personal pronouns I, You, He, She, It, We, You, They, or either any noun or nouns.

FIG. 2a shows a square piece that symbolizes the action of the subject, the stripe showed in this figure, represents a bar of paper that will contain any action verb.

FIG. 3a, shows a rectangular piece that represents an object of a sentence, and the stripe on it, shows an affixed bar of paper that will have the words for any of the object pronouns, or either any noun or nouns.

FIG. 4 shows a star shape green color piece, that represents the interrogative particles why?, when?, where?, how?, what?, and who?.

FIG. 5 shows a flat cross shape green color piece, that contains the auxiliaries “do, does, and did”

FIG. 6 shows a pentagon shape, green color piece, which stands for “can, could, and to be able to”.

FIG. 7 shows a rhombus shape green color piece, that carries on future and other auxiliaries: “will, should, shall, would, may, might and must”.

FIG. 8 shows a triangle shape blue color piece, that represents the auxiliaries “have, has and had”.

FIG. 9 shows a circle shape green color piece, which symbolizes the negative particle not.

FIG. 10 shows a trapezoid shape red color piece, that stands for the derivatives of the auxiliary “to be”: am, are, is, were, was, been, being, and be, when in active voice sentences.

FIG. 11 shows a trapezoid shape blue color piece, same as above FIG. 10, it covers also the derivatives of the auxiliary “to be”, but its application is directed to passive voice expressions.

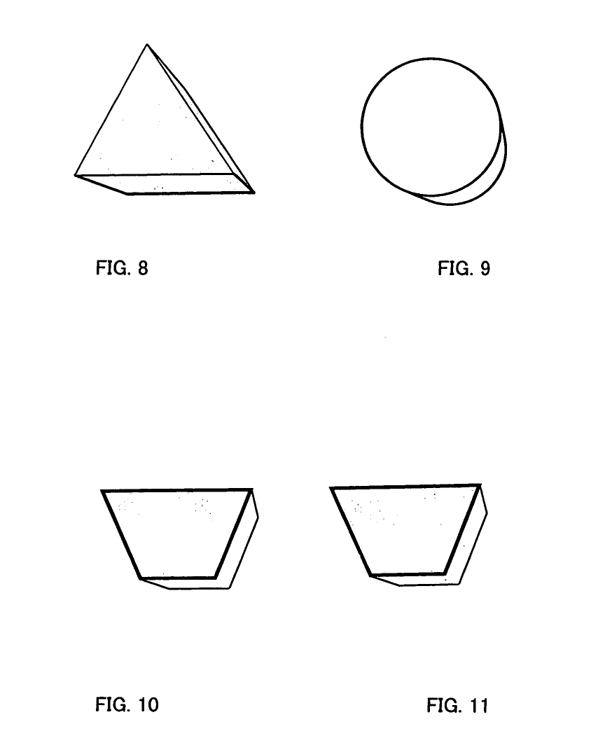

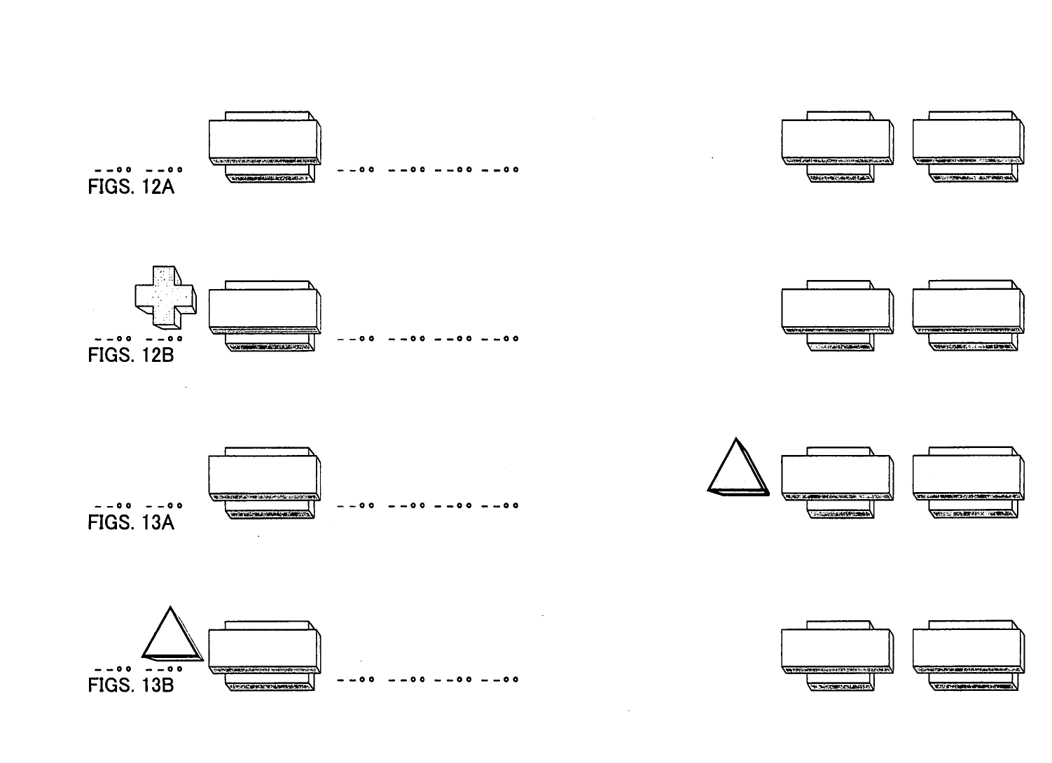

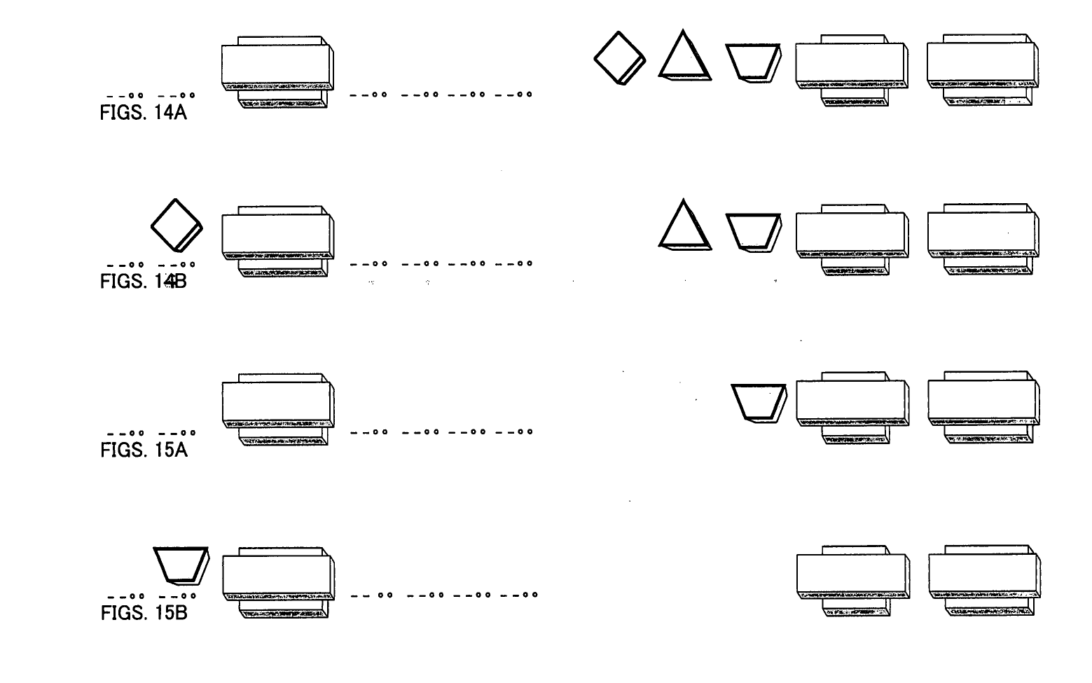

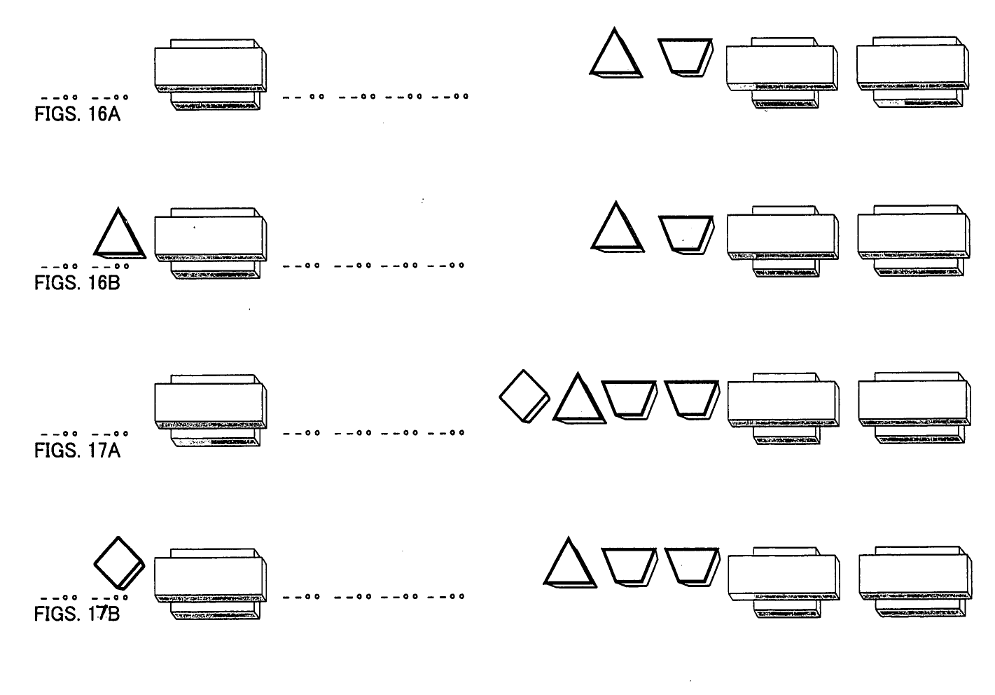

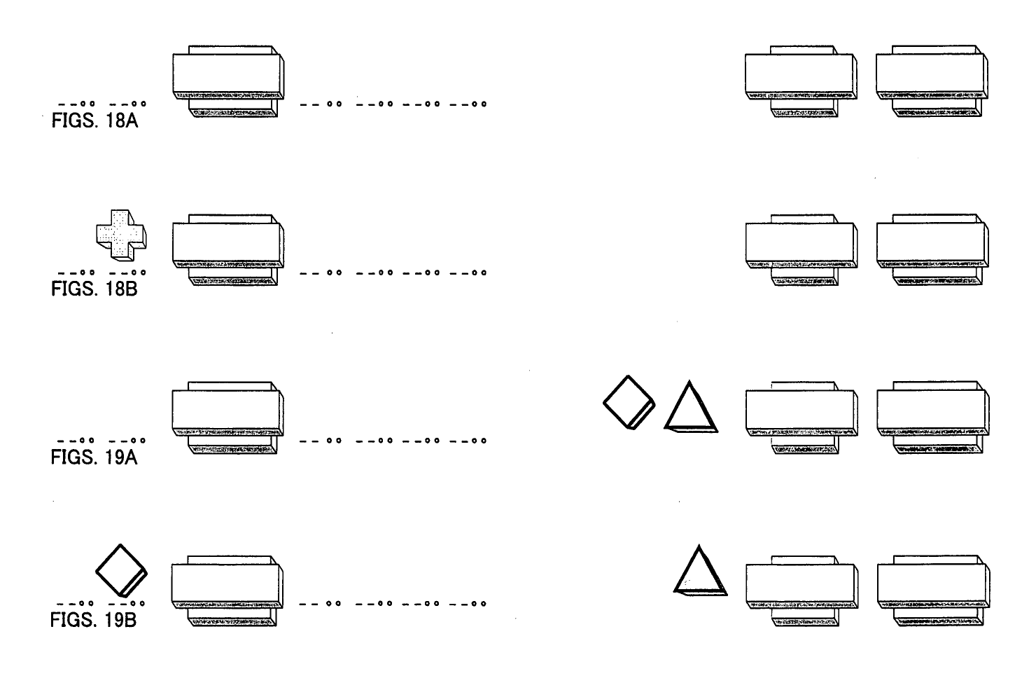

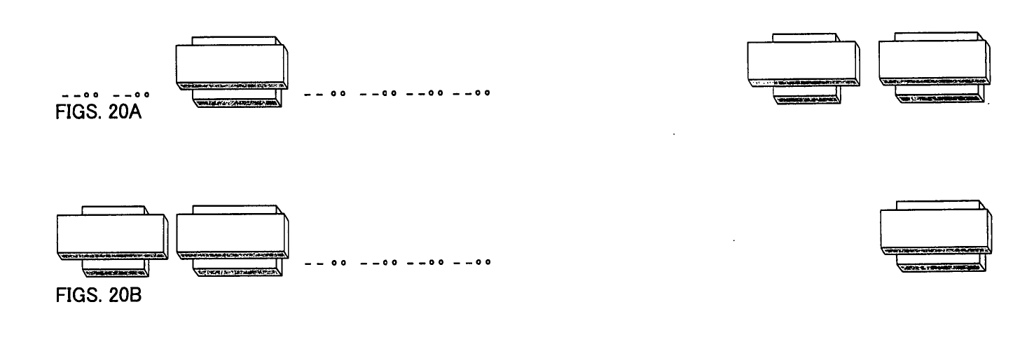

FIGS. 1a to 11 represent eleven pieces made out of cardboard or paper, laminated or not, but strong enough to resist repeatedly handling

Color on pieces 4 to 11: green indicates that the following verb must keep its original letters of infinitive; red increases in the following verb the ending “ing”; blue changes the ending of the next verb, when it is regular, to letters “d” or “ed”; when it is irregular, it uses its corresponding past participle ending.

### DESCRIPTION—FIGS. 1a, 2a, and 3a to 21b—PREFERRED EMBODIMENT

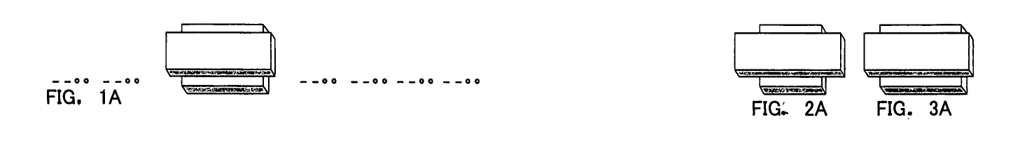

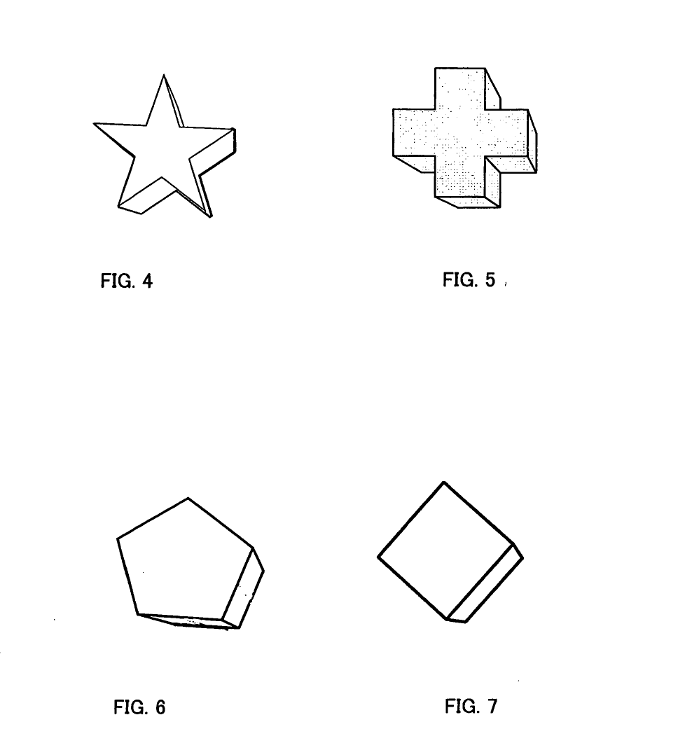

A preferred embodiment of the general structure of this invention is illustrated in FIGS. 1a, to 21b; a fixed structure with the characteristics of a simple declarative sentence of the form subject-verb-object is illustrated by FIGS. 1a, 2a, and 3a, as presented together; FIGS. 1a, and 3a, resemble two rectangle shape pieces with measurements of 10 cm. Long, and 5 cm wide; FIG. 2a, a square with 5 cm by 5 cm, each one of said figures shows a stripe upon, which represents a bar of paper. The paper on piece 1a named subject, will contain words to indicate a noun or a pronoun; the paper on piece 2a named verb will contain words of a simple or compound action verb; the paper on piece 3a named object will contain words to refer to a noun or to any object pronoun.

Pieces structure 1a, 2a, and 3a, arranged in a row, comprises also six blanks −5 cm.long each one—: two slots immediately before piece 1a, and four vacancies after the same piece 1a. One or more different geometric shape pieces, not bigger than 5 cm. By 5 cm., and described on above eight drawing figures with numerals 4 to 11 will as needed occupy such spaces; every one of these eight geometric pieces has color and shape which are their particular characteristics.

Set of FIG. 12a shows the syntax pieces arrangement for an “s-v-o” active voice, simple present tense, declarative kind, sentence.

Set of FIG. 12b shows the syntax pieces arrangement for an “s-v-o” same tense and voice than 12a, but, interrogative kind, sentence.

Set of FIG. 13a shows the syntax pieces organization for an “s-v-o” active voice, past perfect tense, and declarative kind, sentence.

Set of FIG. 13b shows the syntax pieces organization for an “s-v-o” same voice and tense than 31a, but, interrogative kind, sentence.

Set of FIG. 14a shows the syntax pieces structure for an “s-v-o_active voice, future perfect progressive tense and aspect, declarative kind, sentence.

Set of FIG. 14b shows the syntax pieces structure for an “s-v-o” same voice, tense and aspect, as 14a, but, interrogative kind, sentence.

Set of FIG. 15a shows the syntax pieces arrangement for an “o-v-s” passive voice, simple present tense and declarative kind, sentence.

Set of FIG. 15b shows the syntax pieces arrangement for an “o-v-s”, same voice and tense as 15a, but, interrogative kind, sentence.

Set of FIG. 16a shows the syntax pieces organization for an “o-v-s” passive voice, past perfect tense, and declarative kind, sentence.

Set of FIG. 16b shows the syntax pieces organization for an “o-v-s” same voice and tense as 16a, but interrogative kind, sentence.

Set of FIG. 17a shows the syntax pieces structure for an “o-v-s” passive voice, future perfect progressive tense and aspect, and declarative kind, sntence.

Set of FIG. 17b shows the syntax pieces structure for an “o-v-s” same voice, tense and aspect as 17a, but, interrogative kind, sentence.

Set of FIG. 18a shows the syntax pieces structure for an 's-v-o” active, voice, simple present tense, declarative kind, sentence with main verb “To Have”.

Set of FIG. 18b shows the syntax pieces structure for an “s-v-o” same voice, tense and verb as 18a, but, interrogative kind, sentence.

Set of FIG. 19a shows the syntax pieces accommodation for an “s-v-o” active voice, future perfect tense, declarative kind, sentence with main verb “To Have”.

Set of FIG. 19b shows the syntax pieces accommodation for an “s-v-o” same voice, tense and verb as 19a, but, interrogative kind, sentence.

Set of FIG. 20a shows the syntax pieces arrangement for an “s-v-o” active voice, simple present tense, declarative kind, sentence with main verb “To Be”.

Set of FIG. 20b shows the syntax pieces arrangement for an “s-v-o” same voice, tense and verb as 20a, but, interrogative kind, sentence.

FIGS. 1a, 2a, and 3a—Additional Embodiments

There is one more possiblility in regard to the embodiment of pieces 1a, 2a, and 3a, these three pieces with their fixed positiion, may conveniently appear as drawings over a wide sheet of paper to be used in every set of pattern structures.

Advantages

Having these 1a, 2a, and 3a items on a drawing with fixed positions, it becomes easier for the mind to retain this organization of the subject-verb-object sentence.

The above drawings also mean three less pieces to handle during a practicing sequence.

FIGS. 1a-20b Alternative Embodiments

FIGS. 12a to 20b show patterns for simple sentences on two different kinds, declarative and interrogative, as well as voice, tense, mood, and aspect; I recommend to draw pattern charts that include the kinds interrogative-negative, affirmative, and negative, which will allow to come out with 120 to 220 different patterns of the same sentence.

Other embodiments for FIGS. 1a-20b include features on imaginative three dimension items, as well as in computer programs.

Advantages

Imaginative shaped pieces facilitate the learning for blind students; the use of computer programs stimulates the application of creativity by the students working with this method.

Theory of Operation.

My observation of adolescents, and adults throughout their endeavor of studying a second language with different methodologies, shows that their time and effort can be reduced by dividing their tasks in two phases: the first is working with the identified groups of language elements called “Colloquial”, which pertain to the world of verbal communication within family, friends, and “on the job”; the next stage is the academic and industrial literacy level.

Considering that Colloquial Language leads up to a more complex communication system, there appeared the need for a coherent segment in the orthodox elements of the American English Language, such as its phonology, morphology, semantics and syntax. Trying to fulfill this need within a precise and fast approach, I separated these elements, and came out with “Syntax pieces of the Colloquial American English”. This manipulative pieces performance is expected to set in the brain, the basics of the American English Grammar; it will also work as the first step in the design of a program to cover the entire American English Language.

Operation

Using the syntax pieces and their affixed paper bars to help your mind to construct organized sentences, requires a routine: for tense, mood, aspect, kind and elements of a subject-verb-object sentence, first, make a list of the sentences that you plan to work with; next, select the colors of your paper pieces for nouns and pronouns, and for verbs, then write on the stripes of paper, the correspondent words of your sentence; next put in a row from left to right, your 1a, 2a, and 3a syntax items with two spaces before the subject piece, and four after it; subsequently affix each paper stripe to its adequate syntax piece; then, keep on hand your syntax pieces, and put on sight one of the sentences patterns chart. Start your exercise doing the easy ones: active voice, simple present, declarative, interrogative, interrogative-negative, negative, and affirmative; after five to ten drilling times, change tenses to simple past, simple future, and so on; continue adding the perfect, the progressive, and their combinations; in a next phase, work with the passive voice, as well as with other pattern sentences that you can find in any grammar text; do your drilling of each sentence pattern, until you are able to demonstrate a correct manipulation of the sentence pieces without charts or patterns.

### CONCLUSION, RAMIFICATIONS, AND SCOPE

In accordance, it can be seen that the use of syntax pieces for the auxiliary verbs, and interrogative particles, together with affixed pieces of paper that contain categorized words, and organizing altogether with different shapes, positions, and colors into sentence patterns sketches chart, constitutes a technique which allows a fast and clear understanding of grammar rules, as well as their long term memorization; meaning an easy access to the mastery of organizing words, and consequently to the acquisition of fluency in reading, writing and speaking, three skills basic to English as a Second Language Learners, and even to Native English Speakers. Moreover, the syntax items and their affixed paper pieces, have other benefitial features:
They help every person to get familiar with the vocabulary that he or she needs.
They show in an objective form, that grammar rules are sub-codes which can easily be decoded by practicing with different methods alike syntax items.
The drilling of the patterns gives a fast and reliable proficiency, and guarantees the memorization of the grammar rules. Since these patterns of sentences get into the long term memory, they become tools that can be used with alternative vocabulary, tools that allow the access of an easy way to achieve the Colloquial American English.
These patterns provide precise intstructions, as well as clear and immediate results.

This method presents here its basic features, which may seem limited, compared to its potential possibilities; nevertheless, most students of all ages and different areas of interest, who use it, regardless of their schooling level, will receive great advantages, since the method can be approached at a concrete level, using a broad range of manipulatives; furthermore, it can be applied within any word processing or computer program. The highest effectiveness of its operation is achieved when it is used as explained, and along with all the syntax rules, including its related aspects, semantics, phonology, and morphology.

1. Manipulaltive two dimension or three dimension pieces containing a portion of grammar rules of the american english language, and expressing said portion of grammar rules through particularities, position and interrelationship of said manipulative pieces, comprising the steps of:
a) providing predetermined different shape, color and position for said manipulative pieces, and affixed paper bars upon, containing words showing categories of noun, pronoun, and verb
b) codifying and positioning said pieces according to syntax rules on voice, mood, tense and aspect of verbs, auxiliaries, and interrogative particles, into corresponding simple sentences of the form subject-verb-object
c) organizing sentence patterns through geometric figures sketches, showing five different kinds of intention sentences in a chart, as means to model for manipulative pieces on drilling grammatically correct s-v-o predetermined sentences; said patterns drilling as compared with the results on the relevant prior art, substantially decreases time and effort in mastering said portion of grammar of the american english language, and at the same time the plus of mastering lexicon used in said predetermined sentences
whereby each grammar rule of the separated portion of syntax is transformed into a piece, a figure, a position, and a color, therefore its orderly manipulation creates synergism
1.—manipulative two dimension or three dimension pieces containing a portion of grammar rules of the american english language,
2—the manipulative pieces containing a portion of grammar rules of the american english language of claim 1, further including said manipulative pieces made into a computer program.
